(19) United States
(12) Patent Application Publication
(10) Pub. No.: US 2005/0251741 A1
(43) Pub. Date: Nov. 10, 2005

(54) Methods and apparatus for capturing images

(76) Inventors: Maurizio Pilu, Bristol (GB); David Arthur Grosvenor, Frampton Cotterell (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/115,757

(22) Filed: Apr. 27, 2005

(30) Foreign Application Priority Data
Apr. 30, 2004 (GB) 0409673.1

(51) Int. Cl. G06F 17/24

(52) U.S. Cl. 715/520; 715/541

(57) ABSTRACT

Automatic view generation, such as rostrum view generation, may be used beneficially for viewing of still or video images on low resolution display devices such as televisions or mobile. However, the generation of good quality automatic presentations such as rostrum presentations presently requires skilled manual intervention. By recording important parts of the picture at the time of capture time based on conscious and subconscious user actions at the time of capture, extra information may be derived from the capturing process which helps to guide or determine a suitable automatic view generation for presentation of the captured image.

### TECHNICAL FIELD

This invention relates to a method of capturing an image for use in automatic view generation, such as rostrum view generation, to methods of generating presentations and to corresponding apparatus.

### CLAIM TO PRIORITY

This application claims priority to copending United Kingdom utility application entitled, “METHODS AND APPARATUS FOR CAPTURING IMAGES,” having serial no. GB 0409673.1, filed Apr. 30, 2004, which is entirely incorporated herein by reference.

### BACKGROUND

Many methods of capturing images are now available. For example, still images may be captured using analogue media such as chemical film and digital apparatus such as digital cameras. Correspondingly, moving images may be captured by recording a series of such images closely spaced in time using devices such as video camcorders and digital video camcorders. This invention is particularly related to such images held in the electronic domain.

Typically, images must be edited to provide a high quality viewing experience before the images are viewed since inevitably parts of the images will contain material of little interest. This type of editing is typically carried out after the images have been captured and during a preliminary viewing of the images before final viewing. Editing may take the form, for example, of rejecting and/or cropping still images and rejecting portions of a captured moving image.

Such editing typically requires a background understanding of the content of the images in order to highlight appropriate parts of the image during the editing process.

This problem is explained for example in “Video De-abstraction or how to save money on your wedding video”, IEEE workshop on application of computer vision, Orlando, December 2002. This paper describes the use of still photographs from a wedding selected by the wedding couple, to allow automation of editing of videos taken at the same wedding. The paper proposes analysis of the photographs to determine important subjects to be highlighted during the video editing process.

Our co-pending US application No. 2003/0025798, filed on Jul. 30, 2002, and incorporated by reference herein, discloses the possibility of automating a head-mounted electronic camera so that the camera is able to measure user actions such as head and eye movements to determine portions of a video image recorded by the camera, which are of importance. The apparatus may then provide a multi-level “saliency signal” which may be used in the editing process. Our co-pending UK application No. 0324801.0, filed on Oct. 24, 2003, and incorporated by reference herein, also discloses apparatus able to generate a “saliency signal”. This may use user actions such as an explicit control (for example a wireless device such as a ring held on a finger) or inferred actions such as laughter. The apparatus may also buffer image data so that a saliency indication may indicate image data from the time period before the indication was noted by the apparatus.

Our co-pending UK application No. 0308739.2, filed on Apr. 15, 2003, and incorporated by reference herein, describes additional work in the field of automatically interpreting visual clues (so-called “attention cues”) which may be used to determine the identity of objections which have captured a person's interest.

Although this work provides some understanding of how to gather information about the interesting parts of captured images, it is still necessary to find a way to effectively use this information to provide suitably automated viewing generation.

### SUMMARY

A method of capturing an image comprising:
(a) operating image recording apparatus and recording an image;
(b) recording user actions during operation of the recording apparatus; and
(c) associating the recorded user actions with the captured image for use in automatic view generation.

### BRIEF DESCRIPTION OF THE DRAWINGS

Embodiments of the invention will now be described by way of example with reference to the drawings in which:

FIG. 1 is a schematic block diagram of a first embodiment of capture apparatus in accordance with the invention;

FIG. 2 is a schematic block diagram of a further embodiment of capture apparatus in accordance with the invention;

FIG. 3 is a schematic block diagram of a viewing apparatus in accordance with the invention;

FIG. 4A depicts a camera user looking at a scene prior to capturing an image;

FIG. 4B depicts a camera using recording of an image;

FIG. 4C depicts the stored items that were looked at by the camera user;

FIG. 5A depicts the provision of transitions between the recorded points of interest; and

FIG. 5B shows highlighting point of interest by the use of zooming techniques.

### DETAILED DESCRIPTION

In accordance with a first embodiment, there is provided a method of capturing an image comprising operating image recording apparatus, recording user actions during operation of the recording apparatus, recording an image, and associating the recorded user actions with the captured image for use in rostrum generation.

Rostrum camera techniques can be used to display recorded images on a resolution device such as a television or mobile telephone.

This technique involves taking a static image (such as a still image or a frame from a moving image) and producing a moving presentation of that static image. This may be achieved, for example, by zooming in on portions of the image and/or by panning between different portions of the image. This provides a very effective way of highlighting portions of interest in the image and as described below in more detail, those portions of interest may be identified as a result of user actions during capture of the image. Thus, rostrum generation may be considered to mean the automatic generation of a moving view from a static image.

In the prior art, photographs are mounted beneath a computer controlled camera with a variable zoom capability and the camera is mounted on a rostrum to allow translation and rotation relative to the photographs. A rostrum cameraman is skilled in framing parts of the image on the photograph and moving around the image to create the appearance of movement from a still photograph.

Such camera techniques offer a powerful visualisation capability for the display of photographs on low resolution display devices. A virtual rostrum camera moves about the images in the same way as the mechanical system described above by projecting a sampling rectangle onto the photograph's image. A video is then synthesized by specifying the path size and orientation of this rectangle over time. Simple zooming in shows detail that would not be seen otherwise and the act of zooming frame areas of interest. Camera movement and zooming may also be used to maintain interest for an eye used to the continual motion of video.

Automated rostrum camera techniques to synthesize a video from a still image have many arbitrary choices concerning which parts of the image to zoom into, how far to zoom in, how long to dwell on a feature and how to move from one part of an image to another. The invention provides means for acquiring rostrum cues from the camera operator's behaviour at capture time, to resolve the arbitrary choices needed to generate a rostrum video.

It will be appreciated that the invention applies not just to a rostrum video generation from a still image but to the more general case of repurposing a video sequence (copying within a video sequence both spatially and temporarily).

Thus, according to another embodiment, there is provided a method of generating a rostrum presentation comprising receiving image data representative of an image for display, receiving user data representative of user actions, automatically interpreting the user data to determine a point of interest within the image data, and automatically generating a rostrum presentation which highlights the determined point of interest.

In this embodiment, the rostrum cues are received during the viewing method as pre-processed user actions or pre-processed attention detection queues. These may be derived, for example, from sensors on the camera determining movement and orientation or from explicit cues such as control buttons depressed by the camera operator or body actions or sounds made by the camera operator.

In another embodiment of the invention, the invention provides a method of generating a rostrum presentation comprising receiving image data representative of an image for display, extracting user cues from the image data, interpreting the user cues to determine a point of interest within the image data, and automatically generating a rostrum presentation which highlights the determined point of interest.

In this embodiment, the raw image data is processed during the viewing method in order to extract user cues.

The apparatus described below generates a rostrum path for viewing media which takes into account what the camera user was really interested in at capture time. In one embodiment, this is achieved by analysing the behaviour of the camera user around the time of capture in order to detect points of interest or focus of attention that are also visible in the recorded image (whether they be still photos or moving pictures) and to use these points to drive or aid the generation of a meaningful rostrum path.

The rostrum cues can be used to determine the regions of interest, the relative time spent upon a region of interest, the linkages made between regions of interest (for example, the operator's interest moved from this region to the other at some time) and the nature of the transition or path between regions of interest. The observed user behaviour may be used to distinguish between particular rostrum stories or styles (for example, distinguishing between “we were there photographs” in which the story is concerned with both people in the scene and some landmark or landscape, and stories that are purely about the people). One option is to distinguish between posed shots where time is spent arranging the people within photographs with respect to each other and also to the location, and casual shots taken quickly with little preparation.

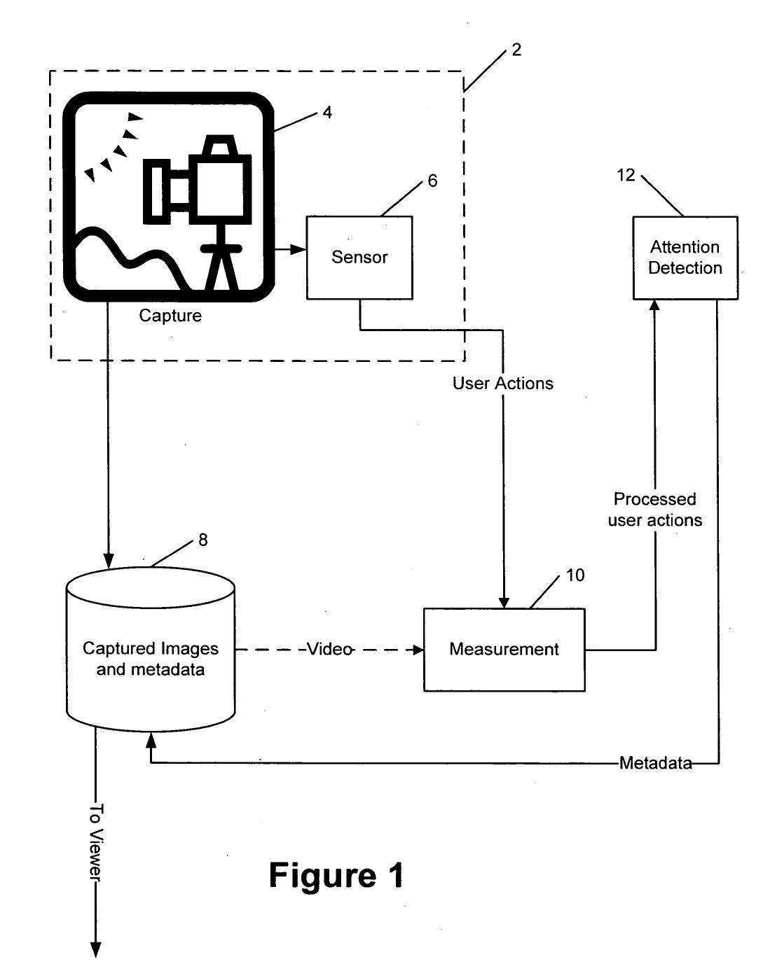

With reference to FIG. 1, a capture device such as a digital stills or video camera 2 includes capture apparatus 4 and sensor apparatus 6. The capture apparatus 4 is generally conventional. A sensor apparatus 6 provides means for determining the points of interest in an image and typically sense user actions around the time of image capture.

For example, the capture device 2 may include a buffer (particularly applicable to the recording of moving images) so that it is possible to include captured images prior to determination of a point of interest by the sensor apparatus 6 (‘historic images’). The sensor may, for example, monitor spatial location/orientation, e.g., user head and eye movements to determine the features which are being studied by the camera operator at any particular time (research having shown that direction faced by a human head is a very good indication of the direction of gaze) and may also monitor transition between points of interest and factors such as the smoothness and speed of that transition.

Further factors which may be sensed may be user's brain patterns, user's movements (for example, pointing at an item) and user's audible expressions such as talking, shouting and laughing. At least some of these factors (some of which are discussed in detail in our co-pending application US 2003/0025798 and UK Application No. 0324801.0) may be used to build up a picture of items of interest within the captured image.

The captured images are recorded in a database 8 and the sensor output is fed to measurement apparatus 10. The measurement apparatus 10 pre-processes the sensor outputs and feeds them to attention detection apparatus 12 which determines points of interest. Attention detection apparatus 12 then generates metadata which describes the potential detection cues and these are recorded in the database 8 along with the captured images.

Thus, the database 8 after processing, includes both the images and metadata which describes points of interest as indicated by user actions at capture time. This information may be fed to the viewing apparatus as discussed below.

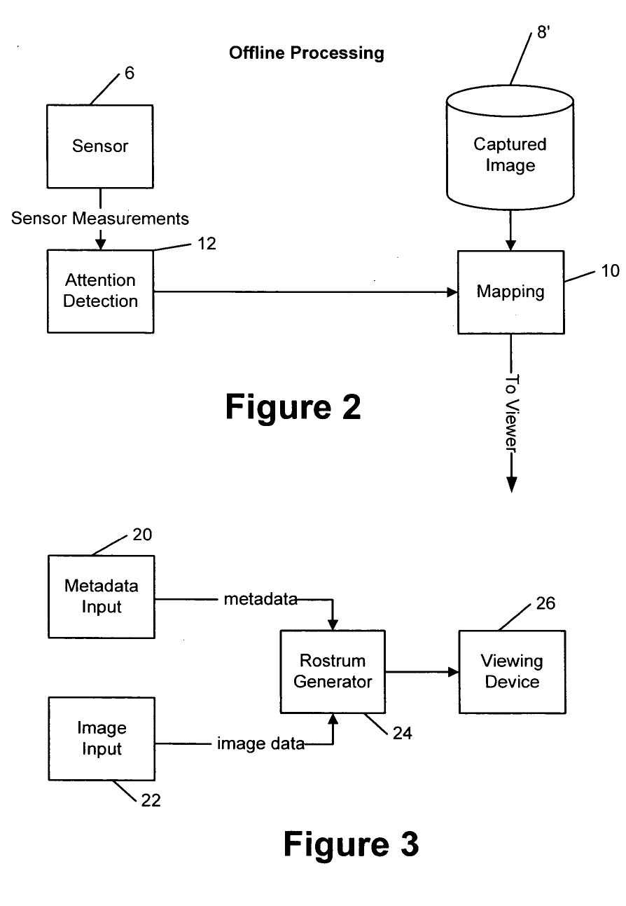

With reference to FIG. 2, an alternative embodiment is disclosed. The capture apparatus is not shown in this figure but broadly speaking it is the same as item 2 in FIG. 1. In this case, however, processing is carried out to produce a direct mapping 100 between the captured image stored in database 18 and attention detection cues derived from measurements recorded by a separate sensor apparatus 16. Thus, the viewing apparatus may be considerably “dumber” since decisions about the relevant points of interest are taken before viewing time. Although this may make for cheaper viewing apparatus, it also reduces flexibility in the choice of type of rostrum presentation.

It will be appreciated that the point at which processing of the sensor information takes place may occur anywhere on a continuum between within the capture apparatus at capture time and within the viewing apparatus at viewing time. By pre-processing the data at capture time, the volume of data may be reduced but the processing capability of the capture apparatus must be increased. On the other hand, simply recording raw image data and raw sensor data (at the other extreme) without any processing at capture time will generate a large volume of data and require increased processing capability and viewing time in a pre-processing step prior to viewing. Thus, the trade-off broadly is between large volumes of data produced at capture time which requires storage and transmittal and on the other hand complexity of a capture device which increases as more pre-processing (and reduction of data volume) occurs in the capture device. The present invention encompasses the full range of these options and it will be understood that processing of sensor measurements, production of metadata, production of attention queues and generation of the rostrum presentation may occur in any or several of the capture device, a pre-processing device or the viewing device.

With reference to FIG. 3, a viewer is shown which is intended to work with the capture apparatus of FIG. 1. However, having regard to the comments above, it will be noted that the capture device may, for example, take raw image data and determine attention cues during or immediately prior to viewing taking place.

The viewing apparatus has a metadata input 20 and image data input 22. These data inputs are synchronised in the sense that the viewing apparatus is able to determine which portions of the image whether it be a still image or a moving image, relate to which metadata. The metadata and image data (both received from the database 8 in FIG. 1) are processed in rostrum generator 24 to produce a rostrum presentation.

Thus, the rostrum generator 24 will typically have image processing capability and will be able to produce zooms, pans and various different transitions based on the image data itself and points of interest within the image data (based on received metadata). Rostrum generator 24 may also take user input which may indicate, for example, the style of rostrum generation which is desired.

The rostrum generator 24 may also, or in the alternative, be arranged to generate one or more single crop options. By using the points of interest determined during user capture, a computer printer may automatically be directed to crop images, for example, to produce a smaller or magnified print.

The output from the rostrum generator 24 may then be stored or viewed directly on a viewing device such as a television or mobile telephone 26.

The general process of capturing and viewing an image will now be described.

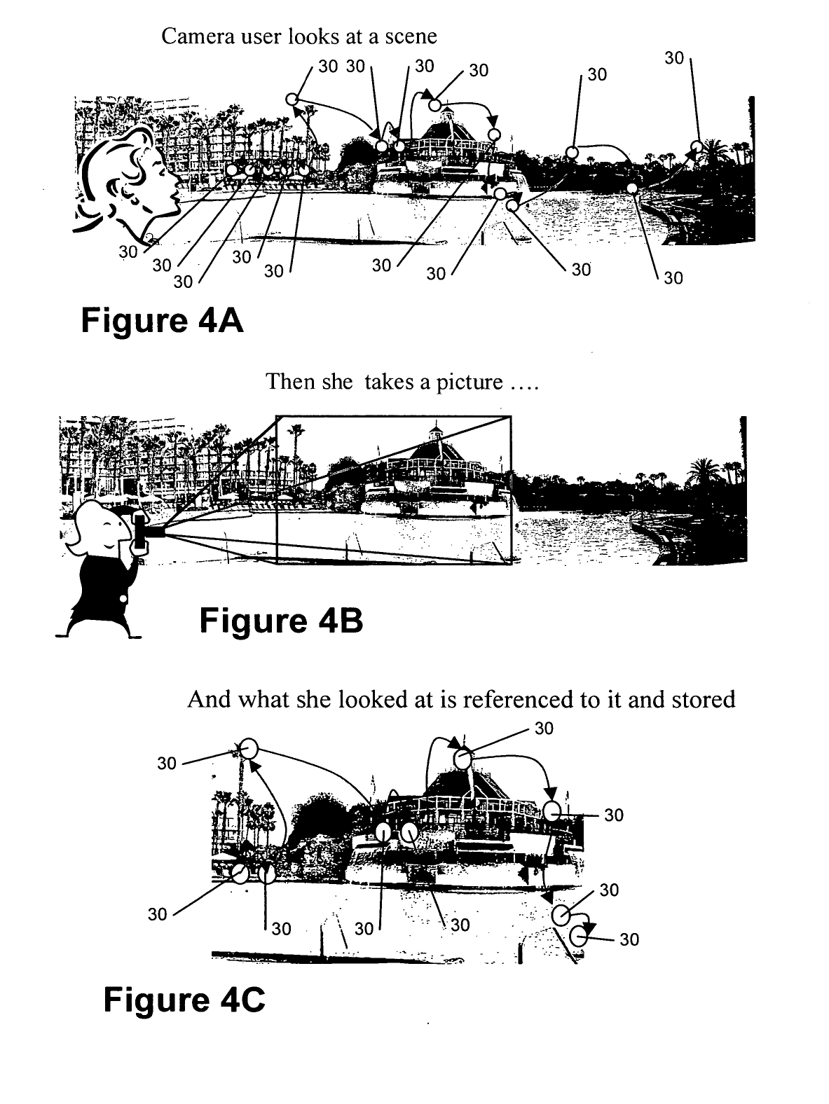

With reference to FIG. 4A, a camera user looks at a scene and hovers over several points of interest 30. The points of interest may be indicated explicitly by the user, for example, by pressing a button on the capture device. Alternatively, the points of interest may be determined automatically. For example, the user may be carrying a wearable camera, mounted within the user's spectacles, having sensors, and from which the attention detection apparatus 12 described in connection with FIG. 1 may establish points of interest automatically from the sensors, such as, for example, by establishing the direction in which she is looking.

In FIG. 4B, the camera user has taken a picture, being a picture of a portion of the scene which is being viewed as FIG. 4A.

In FIG. 4C, the recorded image and metadata describing potential detection cues (generated from the points of interest established by the attention detection apparatus from the sensor movements, for example) and which associate the attention cues to the stored image are stored together.

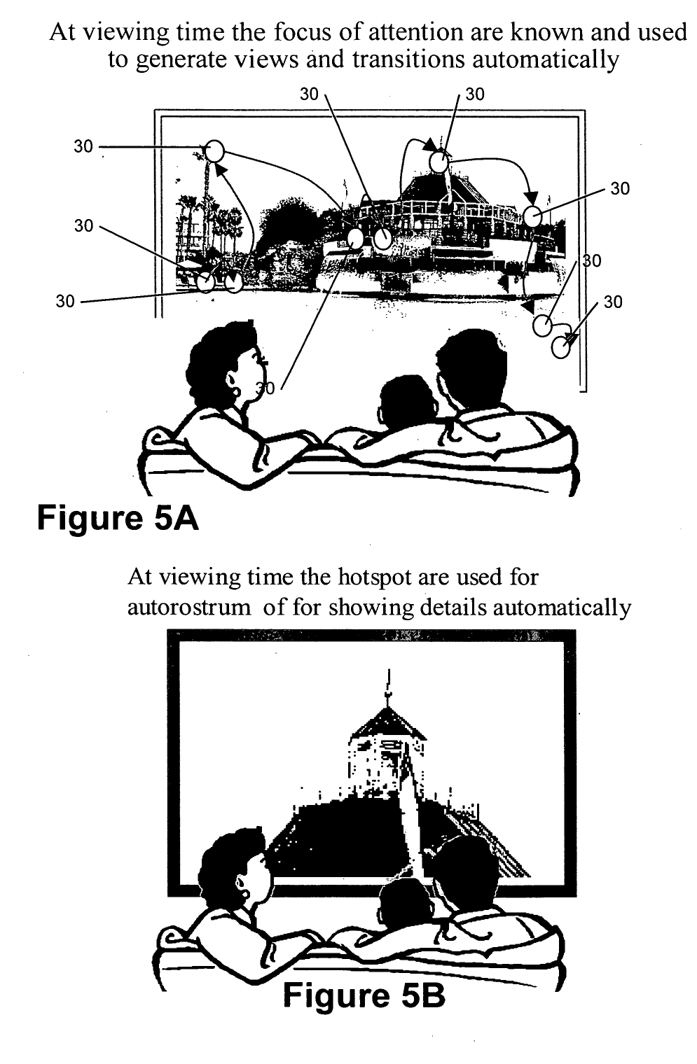

With reference to FIG. 5A, at viewing time, the focus of attention of the operator at capture time is established from the attention cues generated from the points of interest, which were in turn established either automatically or manually at, or shortly after the time of capture. For example, in FIG. 5A it can be seen that the top of the tower is symbolically indicated as being highlighted. In practice, it is most unlikely that the highlighting would be visible on the image itself (since this would be apt to reduce the quality and enjoyment of the image). Rather, salient features of the image are preferably associated with the metadata identifying them as cues at the data file level.

Referring now to FIG. 5B, at viewing time, the important parts of the picture, as determined from these cues highlighted in the image (as represented in FIG. 5A), are preferably then highlighted semantically to the viewer, e.g., using an auto-rostrum technique, which displays such highlighted details automatically, to zoom in on a highlighted feature. Thus, for example, it can be seen that, using rostrum camera techniques, the picture zooms in on the top of the tower, a feature highlighted as being of interest in FIG. 5A.

1. A method of capturing an image, comprising:
(a) operating image recording apparatus and recording the image;
(b) recording user actions during operation of the recording apparatus; and
(c) associating the recorded user actions with the captured image for use in automatic view generation.

2. A method according to claim 1, wherein the user actions are analysed to determine points of interest in the recorded image.

3. A method according to claim 1, wherein the recorded image is a moving image such as a video recording.

4. A method according to claim 1, further comprising recording the user action of where the recording apparatus is pointed before the image is recorded.

5. A method according to claim 1, further comprising recording the user action of where the recording apparatus is pointed after the image is recorded.

6. A method according to claim 5, wherein the recording apparatus is arranged to record historic images automatically for a predetermined period before a user activates recording of the image.

7. A method according to claim 6, wherein the historic images are stored with the recorded image.

8. A method according to claim 6, wherein the historic images are analysed to generate metadata indicating points of interest within the recorded image.

9. A method according to claim 1, further comprising recording user eye data indicative of where the user's eyes are directed before the image is recorded.

10. A method according to claim 1, further comprising recording user eye data indicative of where the user's eyes are directed during image recording.

11. A method according to claim 1, further comprising recording user eye data indicative of where the user's eyes are directed after the image is recorded.

12. A method according to claim 1, further comprising:
recording user eye data; and
storing the user eye data with the recorded image.

13. A method according to claim 1, further comprising:
recording user eye data; and
analysing the user eye data to generate metadata indicating points of interest within the recorded image.

14. A method according to claim 1, further comprising recording sound data representative of a sound made before the image is recorded.

15. A method according to claim 1, further comprising recording sound data representative of a sound made during the image is recorded.

16. A method according to claim 1, further comprising recording sound data representative of a sound made after the image is recorded.

17. A method according to claim 1, further comprising:
recording sound data representative of a sound; and
storing the sound with the recorded image.

18. A method according to claim 1, further comprising:
recording sound data representative of a sound; and
analysing the sound data to generate the metadata indicating the points of interest within the recorded image.

19. A method according to claim 1, further comprising recording user movement data representative of body movements made by a user before the image is recorded.

20. A method according to claim 1, further comprising recording user movement data representative of body movements made by a user during image recording.

21. A method according to claim 1, further comprising recording user movement data representative of body movements made by a user after the image is recorded.

22. A method according to claim 1, further comprising:
recording user movement data representative of body movements made by a user; and
storing the user movement data with the recorded image.

23. A method according to claim 1, further comprising:
recording user movement data representative of body movements made by a user; and
analysing the user movement data to generate the metadata indicating the points of interest within the recorded image.

24. A method according to claim 1, further comprising taking user input such as a button press, via the recording apparatus which is given to record a point of interest.

25. A method according to claim 1, further comprising monitoring a spatial location of the recording apparatus.

26. A method according to claim 1, further comprising monitoring an orientation of the recording apparatus.

27. A method according to claim 1, further comprising:
taking data from a second recording apparatus located separately from, but nearby, the image recording apparatus; and
using the data from the second recording apparatus to determine points of interest in the images recorded by the recording apparatus.

28. A method according to claim 1, further comprising monitoring brain wave patterns of a user to determine points of interest in the images.

29. A method according to claim 1, further comprising:
monitoring head and eye movements of a user to determine at least one of head motion, fixation on particular objects and/or smoothness of trajectory between objects of interest; and
to determining points of interest in the images from the monitored movement.

30. An image recording apparatus comprising:
an image sensor;
storage means for storing images; and
sensor means for sensing actions of an apparatus user approximately at a time of image capture.

31. An apparatus according to claim 30, further comprising a processor means for processing an output of the sensor means to determine points of interest in the images recorded by the apparatus.

32. An apparatus according to claim 31, wherein the storage means is adapted to store metadata produced by the processing means which describes the output of the sensor means.

33. An apparatus according to claim 31, wherein the storage means is adapted to store metadata produced by the processing means which describes points of interest in the images recorded by the apparatus.

34. A method of automatically generating a presentation, comprising:
(a) receiving image data recording an image for display;
(b) receiving user data recording user actions;
(c) automatically interpreting the user data to determine a point of interest within the image data; and
(d) automatically generating a presentation which highlights the determined point of interest.

35. A method according to claim 34, further comprising using zoom and pan techniques to highlight the point of interest.

36. A method according to claim 34, further comprising generating a number of crop options.

37. A method of automatically generating a presentation, comprising:
(a) receiving image data representative of an image for display;
(b) extracting user cues from the image data;
(c) interpreting the user cues to determine a point of interest within the image data; and
(d) automatically generating the presentation which highlights the determined point of interest.
